(19) United States
(12) Patent Application Publication
(10) Pub. No.: US 2025/0329949 A1
(43) Pub. Date: Oct. 23, 2025

(54) ELECTRICAL CONNECTOR MANUFACTURING METHOD AND STRUCTURE FOR THE SAME

(71) Applicant: ZHEJIANG ZHAOLONG INTERCONNECT TECHNOLOGY CO., LTD., Zhejiang (CN)

(72) Inventors: Shi-Jung CHEN, Zhejiang (CN); Chun-Hsu CHEN, Zhejiang (CN); Donghua NI, Zhejiang (CN)

(73) Assignee: ZHEJIANG ZHAOLONG INTERCONNECT TECHNOLOGY CO., LTD., Zhejiang (CN)

(21) Appl. No.: 19/070,317

(22) Filed: Mar. 4, 2025

(30) Foreign Application Priority Data
Apr. 17, 2024 (TW) 113114336

(51) Int. Cl. H01R 12/71; H01R 12/62; H01R 12/70; H01R 13/405; H01R 13/504; H01R 13/6589; H01R 13/6594

(52) U.S. Cl. CPC H01R 12/712; H01R 12/62; H01R 13/405; H01R 13/504; H01R 13/6589; H01R 13/6594; H01R 12/707

(57) ABSTRACT

An electrical connector manufacturing method includes following steps. At least one conductive-wire set is provided. The conductive-wire set is composed of conductive wires. The conductive wires include core wires and ground wires. A metal frame is installed on the conductive wires. The ground wires are bent and electrically connected onto a top part and a bottom part of the metal frame. A plastic material covers the conductive wires through an injection molding technology. A circuit board is electrically connected to the core wires. At least one metal housing is provided and is installed on the top part of the metal frame. The metal housing is electrically connected to the metal frame and the circuit board. Since the ground wires are bent and electrically connected onto the top part and the bottom part, a left-to-right width of the electrical connector is reduced after the electrical connector is assembled.

### BACKGROUND OF THE DISCLOSURE

### Technical Field

The present disclosure relates to an electrical connector, and especially relates to an electrical connector manufacturing method and a structure for the same.

### Description of Related Art

An electrical connector is a conductive apparatus that connects electrical lines. This component may be used as an end point for connecting different components in the same circuit system, or may provide power and data connections between different circuit systems and electronic apparatuses.

When a related art electrical connector is manufactured, outer coverings of a plurality of conductive wires in one row or two rows are first stripped off, so that a plurality of core wires and a plurality of ground wires of the conductive wires are exposed. Then, the exposed core wires are electrically connected to a circuit board. At the same time, the ground wires are electrically connected to a metal frame (or a metal housing) which sleeves on the cable (which includes the conductive wires) to form a ground loop for ground isolation and noise elimination.

Since the ground wires of the related art electrical connector mentioned above are bent on the left side and the right side of the metal frame (or the metal housing), after the entire related art electrical connector is assembled, the left-to-right width of the related art electrical connector is larger. Whether the related art electrical connector is used in a transmission line or is directly installed on a motherboard of an electronic apparatus, the motherboard must have enough space to install the related art electrical connector, otherwise the related art electrical connector will not be able to be plugged into the motherboard. If the related art electrical connector is to be plugged into the motherboard, the size of the motherboard must be large enough.

Therefore, how to improve and reduce the left-to-right width of the electrical connector is a problem to be solved in the present disclosure.

### SUMMARY OF THE INVENTION

Therefore, the main object of the present disclosure is to provide a new manufacturing method and structural design of an electrical connector. Mainly the ground wires inside the conductive wires of the electrical connector are bent at the top part and the bottom part of the metal frame of the electrical connector, and are electrically connected to the metal frame. A left-to-right width of the electrical connector is reduced after the electrical connector is assembled.

To achieve the object mentioned above, the present disclosure provides an electrical connector manufacturing method including following steps. At least one conductive-wire set is provided. The conductive-wire set is composed of (namely, includes) a plurality of conductive wires. Outer coverings of the conductive wires are removed to expose a plurality of core wires and a plurality of ground wires (for example, a portion of the outer coverings of the conductive wires are removed so the core wires and the ground wires are exposed outside the outer coverings). The ground wires are bent onto one side of the conductive wires (for example, the ground wires are bent onto the outer coverings of the conductive wires). Then, at least one metal frame is provided, and is installed on the conductive wires so the ground wires which are bent are located on outer surfaces of a top part and a bottom part of the metal frame, and is electrically connected to the top part and the bottom part of the metal frame. Then, a plastic material covers the conductive wires through an injection molding technology to form a fixing base. A part of the fixing base is located between the conductive wires and the metal frame. The other part of the fixing base is located on a rear side of the metal frame. A circuit board is provided and is electrically connected to the core wires. Finally, at least one metal housing is provided and is installed on the top part of the metal frame. The metal housing is electrically connected to the metal frame and the circuit board.

In an embodiment of the present disclosure, the metal frame includes two positioning parts, a slit, and a support plate. The two positioning parts are symmetrical and perforated-shaped on the top part. The slit is located between the two positioning parts. Moreover, the support plate is located on the bottom part of the metal frame, and is bent inside the metal frame and into the slit.

In an embodiment of the present disclosure, the fixing base includes a front section and a rear section. The front section is located between the metal frame and the conductive wires. The rear section extends from the front section of the fixing base. The rear section is located at the rear side of the metal frame.

In an embodiment of the present disclosure, the circuit board includes a signal conductive line, a plurality of conductive terminals, a plurality of electrical pins, a plurality of ground pins, and a protruding board. The signal conductive line is arranged on the circuit board. The conductive terminals are located on one front side or two front sides of the circuit board, and are electrically connected to the signal conductive line. The electrical pins and the ground pins are located on one rear side or two rear sides of the circuit board. The protruding board extends from a rear end of the circuit board. The protruding board inserts between the conductive wires of the two conductive-wire sets, so that the core wires of the conductive wires are electrically connected to the electrical pins.

In an embodiment of the present disclosure, the metal housing includes two through holes, an opening, a plurality of metal pins, and two fins. The two through holes are symmetrical to each other, and are located on one side of the metal housing, and are correspondingly positioned on the positioning parts of the metal frame. The opening is located between the two through holes, and corresponds to the slit. Moreover, the metal pins are located at a front end of the metal housing, and are electrically connected to the ground pins. Moreover, the two fins are located at both sides of the metal housing respectively, and on both sides of the metal frame respectively.

In an embodiment of the present disclosure, an adhesive tape is further included and pastes on the rear section of the fixing base and an outside of the metal housing to form an insulating layer.

In an embodiment of the present disclosure, the insulating layer is a high temperature resistant tape.

In an embodiment of the present disclosure, the metal housing includes a plurality of partition plates. The partition plate is U-shaped. When the metal housing is installed on the metal frame, each of the partition plates correspondingly covers single one of the conductive wires, and the partition plates are electrically connected to the ground pins, so that the core wires of the conductive wires block noise interferences on three sides.

To achieve the object mentioned above, the present disclosure further provides an electrical connector structure including at least one conductive-wire set, at least one metal frame, a fixing base, a circuit board, and at least one metal housing. The conductive-wire set is composed of (namely, includes) a plurality of conductive wires. The conductive wires include a plurality of core wires and a plurality of ground wires. The ground wires are bent onto one outside of the conductive wires (for example, the ground wires are bent onto outer coverings of the conductive wires). The metal frame is installed on the conductive-wire set, and includes a top part and a bottom part, so the ground wires which are bent are located on and electrically connected to outer surfaces of the top part and the bottom part. The fixing base includes a front section and a rear section. The front section is located between the metal frame and the conductive wires. The front section extends backward to form the rear section. The rear section is located at a rear side of the metal frame. The circuit board is electrically connected to the core wires. The metal housing is installed on the top part of the metal frame, and is electrically connected to the metal frame and the circuit board.

In an embodiment of the present disclosure, the metal frame includes two positioning parts, a slit, and a support plate. The two positioning parts are symmetrical and perforated-shaped on the top part. The slit is located between the two positioning parts. The support plate is located on the bottom part, and is bent inside the metal frame and into the slit.

In an embodiment of the present disclosure, the circuit board includes a signal conductive line, a plurality of conductive terminals, a plurality of electrical pins, a plurality of ground pins, and a protruding board. The signal conductive line is arranged on the circuit board. The conductive terminals are located on one front side or two front sides of the circuit board, and are electrically connected to the signal conductive line. The electrical pins and the ground pins are located on one rear side or two rear sides of the circuit board. The protruding board extends from a rear end of the circuit board. The protruding board inserts between the conductive wires of the two conductive-wire sets, so that the core wires of the conductive wires are electrically connected to the electrical pins.

In an embodiment of the present disclosure, the metal housing includes two through holes, an opening, a plurality of metal pins, and two fins. The two through holes are symmetrical to each other, and are located on one side of the metal housing, and are correspondingly positioned on the positioning parts of the metal frame. The opening is located between the two through holes, and corresponds to the slit. Moreover, the metal pins are located at a front end of the metal housing, and are electrically connected to the ground pins so a ground loop is formed between the conductive wires and the circuit board. Moreover, the fin is located on each side of the metal housing. The two fins are located on both sides of the metal frame respectively.

In an embodiment of the present disclosure, the fixing base is made of a plastic material.

In an embodiment of the present disclosure, the electrical connector structure further includes an insulating layer pasting on the rear section of the fixing base and an outside of the metal housing.

In an embodiment of the present disclosure, the insulating layer is a high temperature resistant tape.

In an embodiment of the present disclosure, the metal housing includes a plurality of partition plates. The partition plate is U-shaped. When the metal housing is installed on the metal frame, each of the partition plates correspondingly covers single one of the conductive wires, and the partition plates are electrically connected to the ground pins, so that the core wires of the conductive wires block noise interferences on three sides.

### BRIEF DESCRIPTION OF THE DRAWINGS

FIG. 1 shows a schematic flow chart of the steps of the manufacturing method of the electrical connector structure of the present disclosure.

FIG. 2 shows a schematic diagram of the assembly of the conductive wires and the two metal frames of the present disclosure.

FIG. 3 shows a schematic diagram of the semi-finished product of FIG. 2 undergoing the injection molding of the fixing base.

FIG. 4 shows a schematic diagram of electrically connecting the conductive wires of the semi-finished product to the circuit board after the injection molding step in FIG. 3.

FIG. 5 shows a schematic diagram of the two metal housings assembled on the two metal frames of the semi-finished product in FIG. 4.

FIG. 6 shows a schematic diagram of the semi-finished product in FIG. 5 being pasted/sealed with the insulating layer.

FIG. 7 shows a partially enlarged schematic diagram of FIG. 6.

FIG. 8 shows a schematic cross-sectional view of FIG. 7 at the position 8-8.

FIG. 9 shows a partially enlarged schematic diagram of FIG. 8.

FIG. 10 shows a schematic cross-sectional view of FIG. 7 at the position 10-10.

FIG. 11 shows a schematic cross-sectional view of FIG. 7 at the position 11-11.

FIG. 12 shows a schematic diagram of another embodiment of the present disclosure.

FIG. 13 shows a schematic diagram of the three-dimensional assembly of FIG. 12.

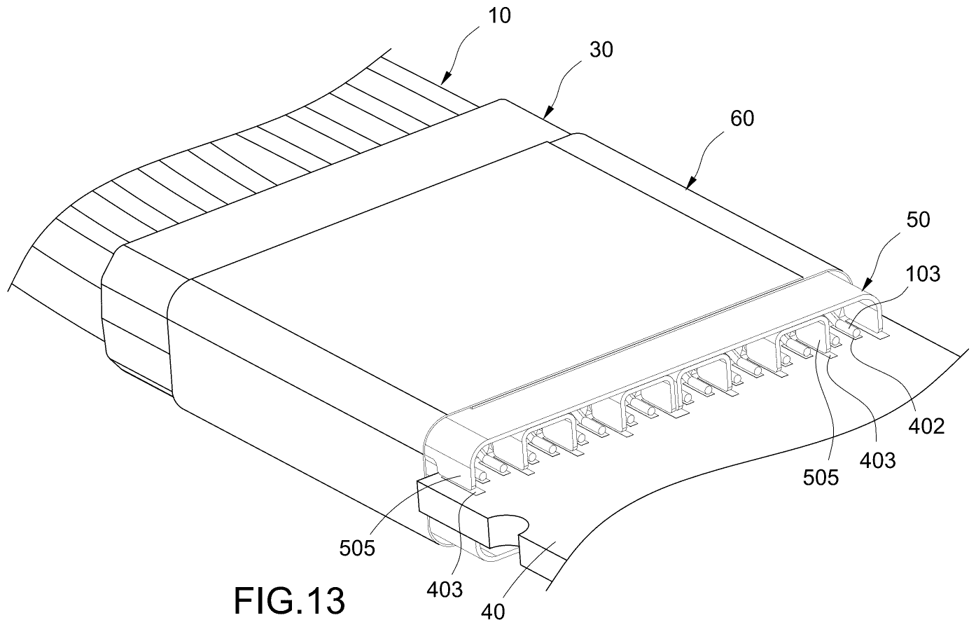

### DETAILED DESCRIPTION

The technical content and detailed description of the present disclosure are now described as follows together with the drawings:

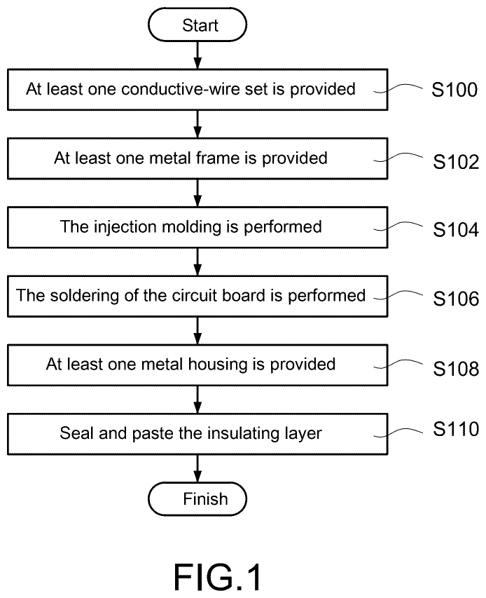

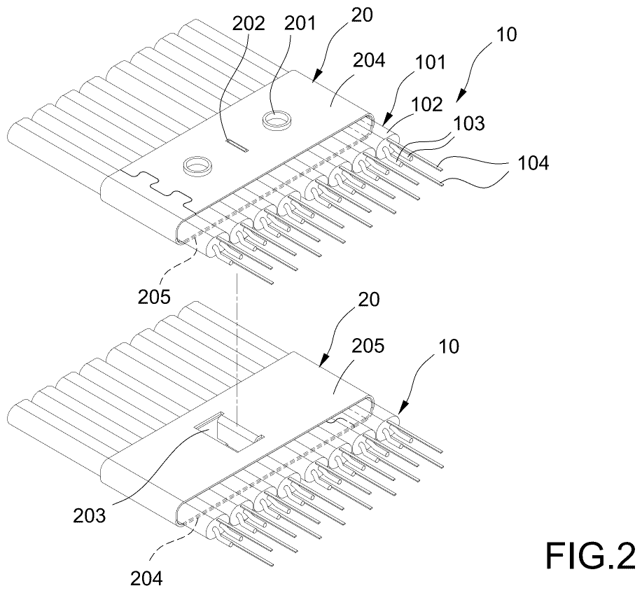

FIG. 1 shows a flow chart of the steps of the manufacturing method of the electrical connector structure 1 of the present disclosure. FIG. 2 to FIG. 11 show schematic diagrams of the semi-finished product structure of the electrical connector structure 1 of the present disclosure. Please refer to FIG. 1 to FIG. 11. As shown in FIG. 1, when the electrical connector structure 1 of the present disclosure is manufactured, the manufacturing method of the electrical connector structure 1 of the present disclosure includes following steps. The first step S100: at least one conductive-wire set is firstly provided. In the drawings, there are two conductive-wire sets. The conductive-wire set 10 is composed of (namely, includes) a plurality of conductive wires 101. After an outer covering (plastic skin) 102 (for example, one part of the outer covering 102) of each conductive wire 101 is removed, the core wires 103 and the ground wires 104 inside the conductive wire 101 are exposed (for example, outside the outer covering 102). After the ground wires 104 are exposed, the ground wires 104 are bent onto one side of the outer coverings 102 or adjacent to the outer coverings 102.

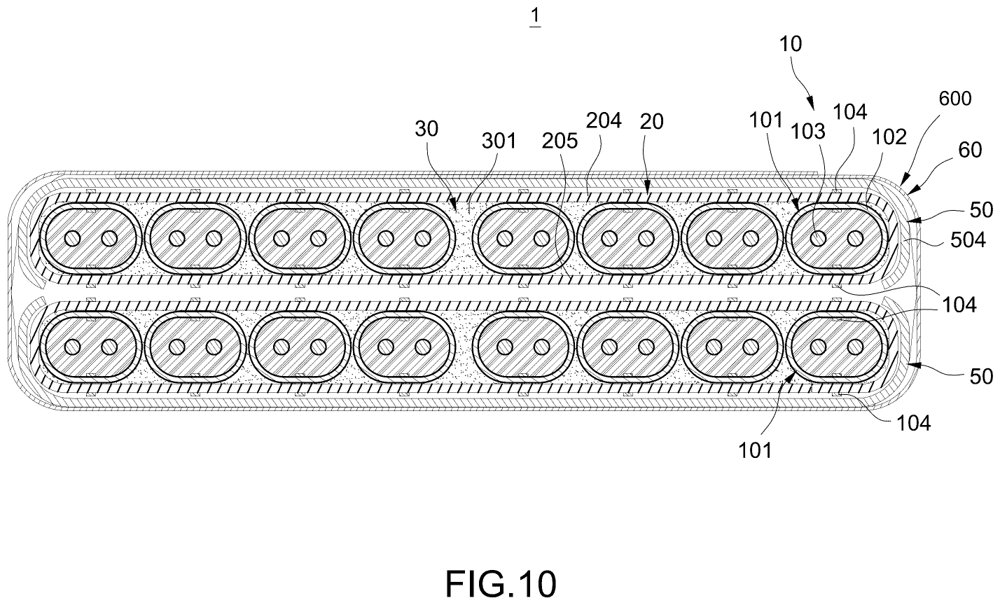

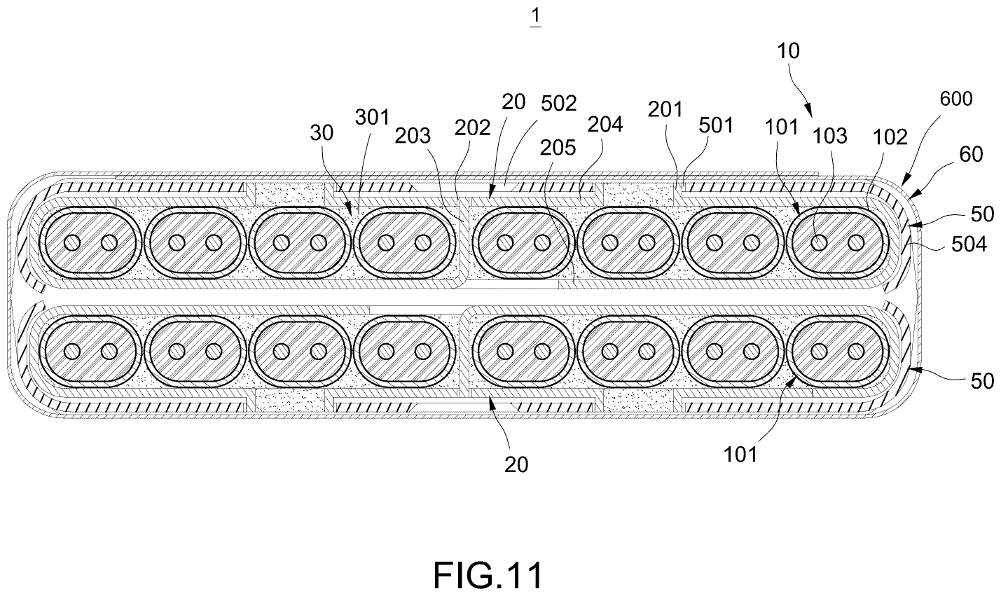

Step S102: at least one metal frame is provided. In the drawings, there are two metal frames. The metal frame 20 includes two positioning parts 201, a slit 202, and a support plate 203. The two positioning parts 201 are symmetrical and perforated-shaped on a top part 204 of the metal frame 20. The slit 202 is located between the two positioning parts 201. Moreover, the support plate 203 is located on bottom parts 205 of the two metal frames 20, and is bent inside the two metal frames and into the slit 202 (as shown in FIG. 11) to prevent the two metal frames 20 from being crushed or deformed by external forces. After the two metal frames 20 sleeve on the conductive wires 101 of the two conductive-wire sets 10, the ground wires 104 of the conductive wires 10 are bent and located on outer surfaces of the top parts 204 and the bottom parts 205 of the two metal frames 20, and are electrically connected to the top parts 204 and the bottom parts 205 of the two metal frames 20 (as shown in FIG. 2 and FIG. 10). Ground signals may be induced on the two metal frames 20 to form a ground isolation state to eliminate noises and to prevent transmitted signals from being interfered.

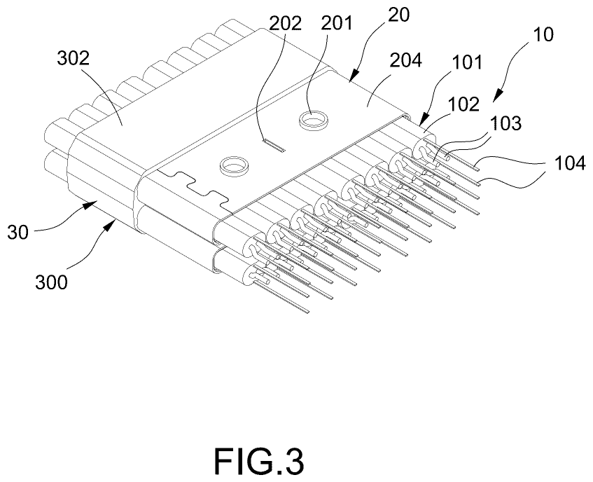

Step S104: the injection molding is performed. A plastic material 300 is injected and covers the conductive wires 101 of the two conductive-wire sets 10 through an injection molding machine to form a fixing base 30. A front section 301 of the fixing base 30 is located between the metal frame 20 and the conductive wires 101 (as shown in FIG. 3, FIG. 10, and FIG. 11). A rear section 302 of the fixing base 30 is located on a rear side of the two metal frames 20, so that the fixing base 30 may firmly fix the two conductive-wire sets 10 and the two metal frames 20.

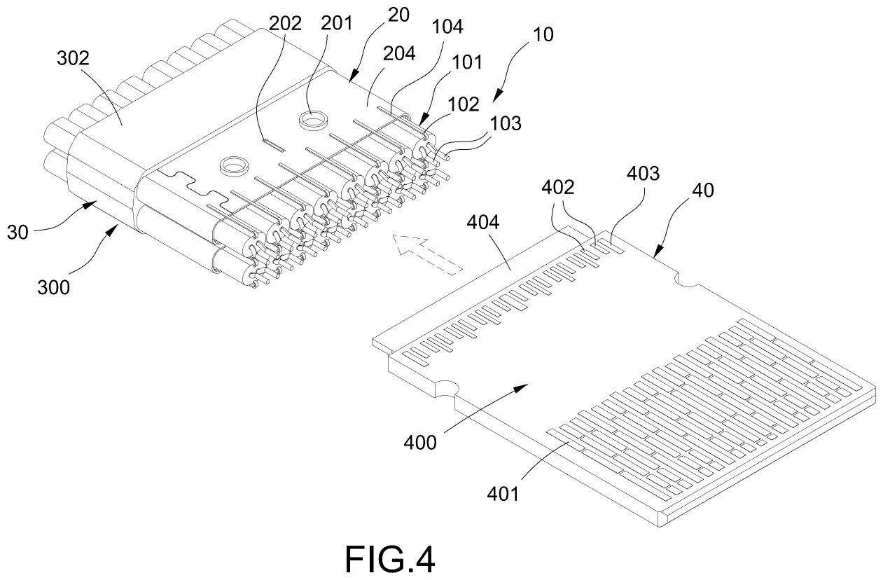

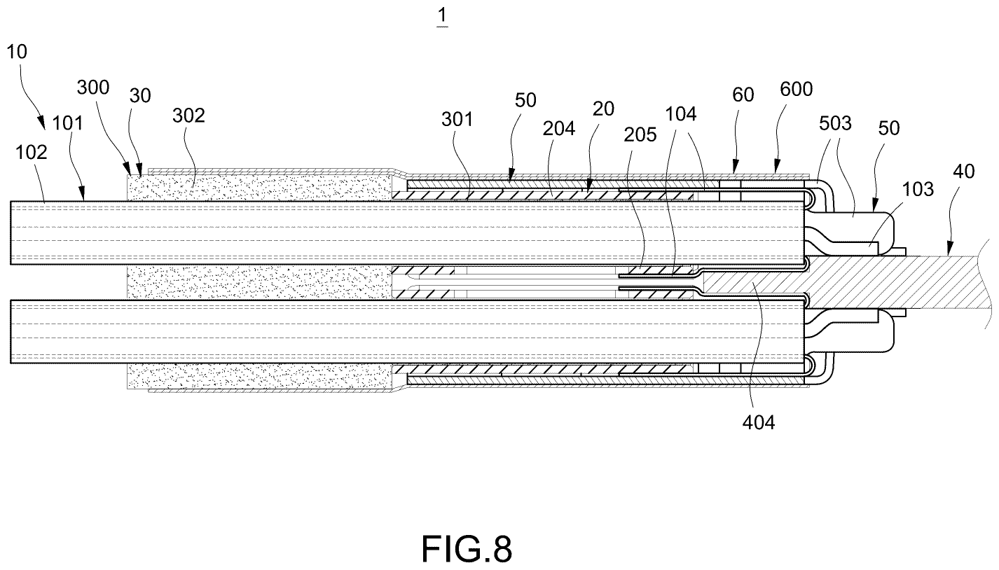

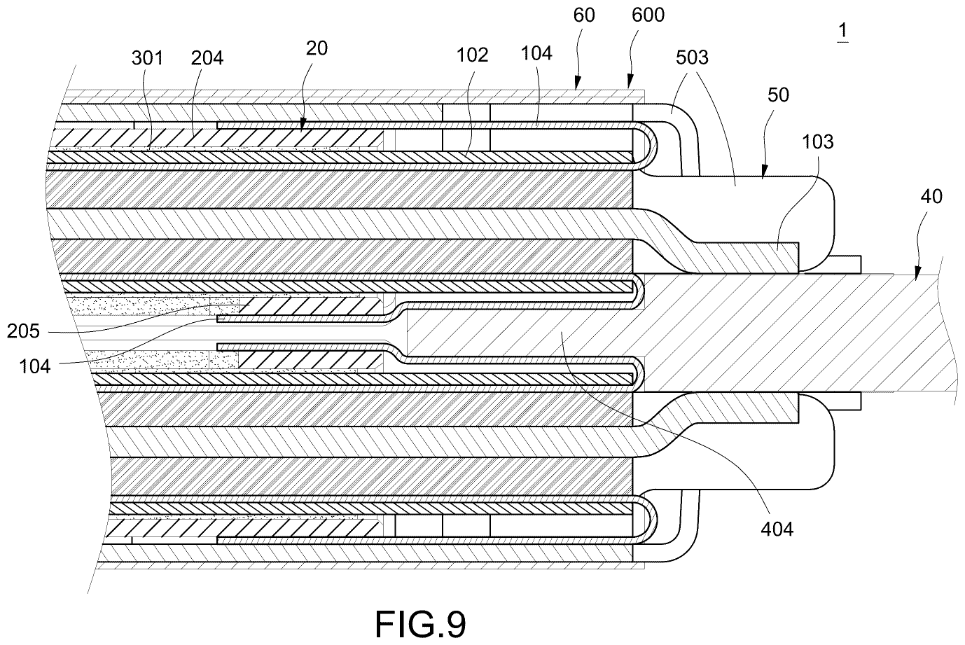

Step S106: the soldering of the circuit board is performed. After the injection molding mentioned above is performed, the soldering of the circuit board 40 is performed. The circuit board 40 includes a signal conductive line 400, a plurality of conductive terminals 401, a plurality of electrical pins 402, a plurality of ground pins 403, and a protruding board 404. The signal conductive line 400 is arranged on the circuit board 40. The conductive terminals 401 are located on one front side or two front sides of the circuit board 40, and are electrically connected to the signal conductive line 400. The electrical pins 402 and the ground pins 403 are located on one rear side or two rear sides of the circuit board 40. The protruding board 404 extends from a rear end of the circuit board 40. The protruding board 404 inserts between the conductive wires 101 of the two conductive-wire sets 10, so that the core wires 103 of the conductive wires 101 are electrically connected to the electrical pins 402 (as shown in FIG. 4, FIG. 8, and FIG. 9).

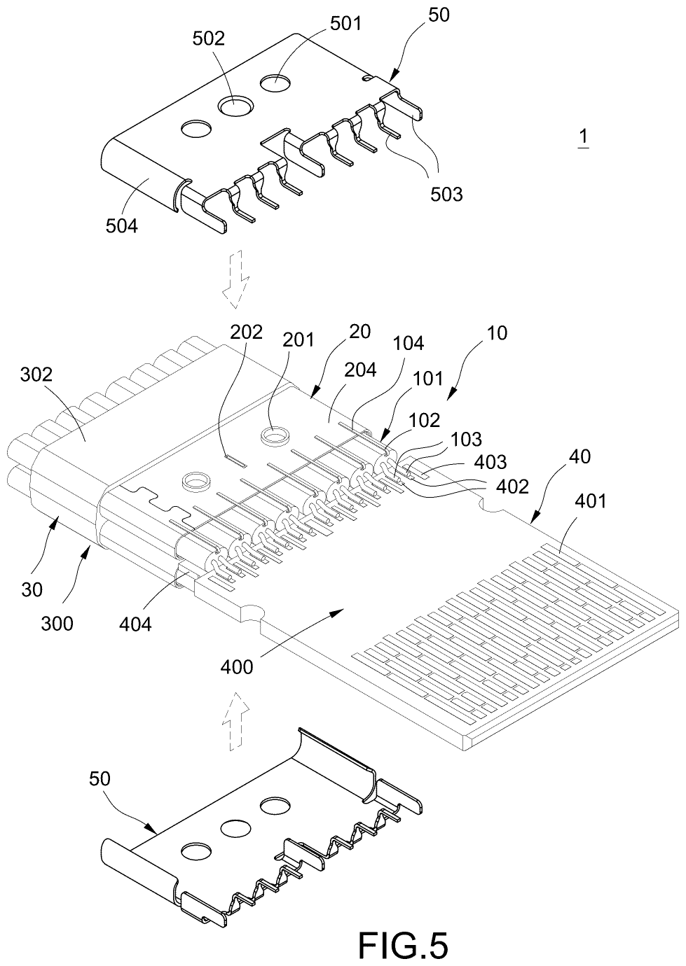

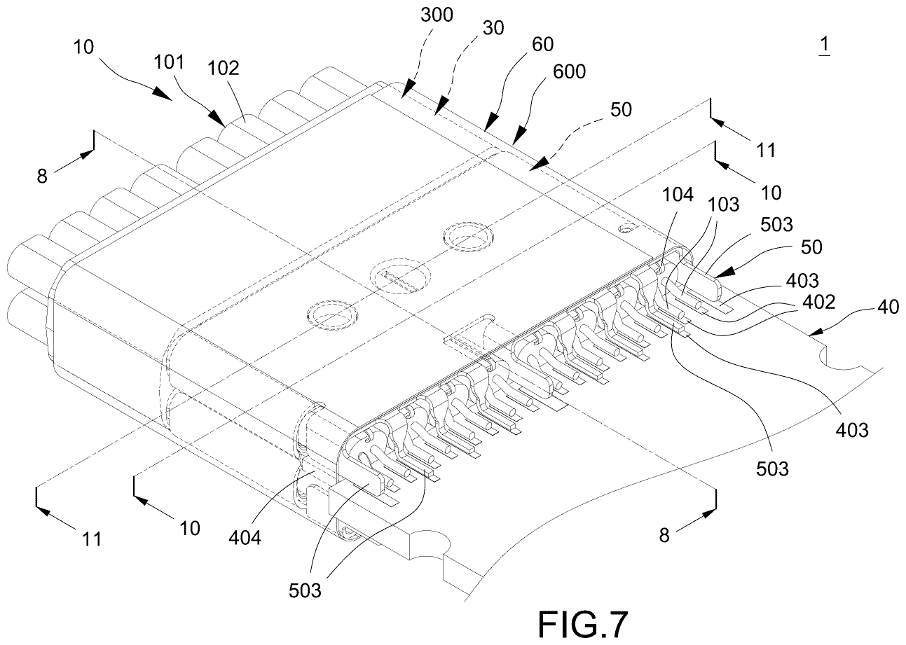

Step S108: at least one metal housing is provided. In the drawings, there are two metal housings. The metal housings 50 are installed. The metal housing 50 includes two through holes 501, an opening 502, a plurality of metal pins 503, and two fins 504. The two through holes 501 are symmetrical to each other, and are located on one side of each of the two metal housings 50, and are correspondingly positioned on the positioning parts 201 of each of the two metal frames 20. The opening 502 is located between the two through holes 501, and corresponds to the slit 202. Moreover, the metal pins 503 are located at a front end of the metal housing 50, and are electrically connected to the ground pins 403, so that a ground loop is formed between the conductive wires 101 and the circuit board 40 to eliminate the noises and form the ground isolation to prevent the transmitted signals from being interfered. Moreover, the fins 504 on both sides of the two metal housings 50 are located on both sides of the two metal frames 20 to prevent the both sides of the metal frames 20 from being squeezed and deformed (as shown in FIG. 5, FIG. 7, FIG. 8, FIG. 9, FIG. 10, and FIG. 11).

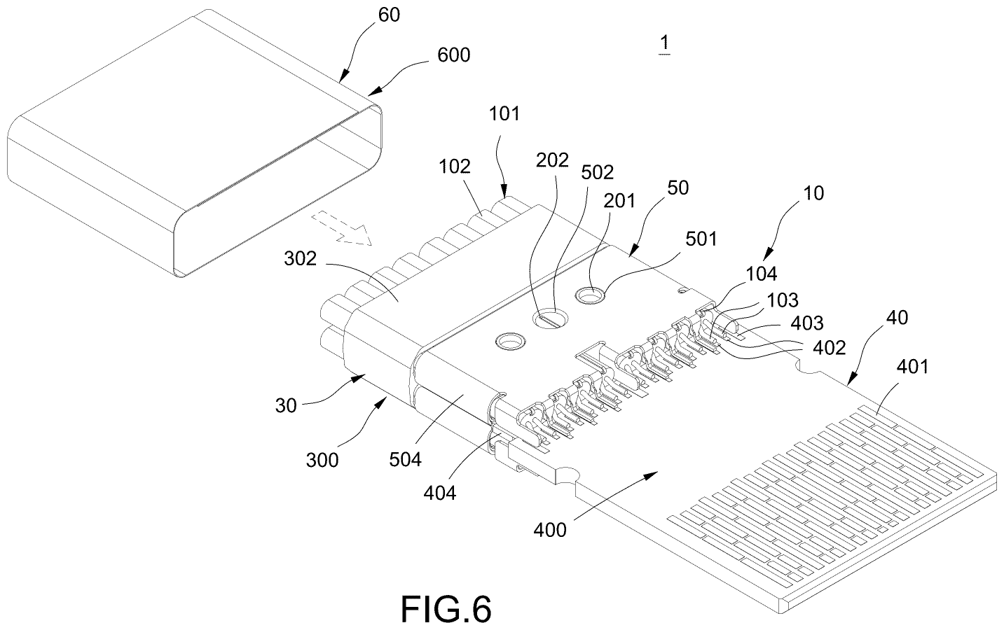

Step S110: Seal and paste the insulating layer. After the two metal housings 50 mentioned above are installed, an adhesive tape 600 is used to paste on and cover the rear section 302 of the fixing base 30 and an outside of the two metal housings 50 to form an insulating layer 60 to prevent the connector from the short-circuiting phenomenon (as shown in FIG. 6, FIG. 7, FIG. 8, FIG. 9, FIG. 10, and FIG. 11). In the drawings, the insulating layer 60 is a high temperature resistant tape.

Through the above-mentioned process of the steps S100 to S110, the production and installation of the overall electrical connector structure 1 may be completed, so that the ground wires of the electrical connector structure 1 are bent at the top part (upper) and the bottom part (lower) of the two metal frames 20 to reduce the left-to-right width of the electrical connector structure 1.

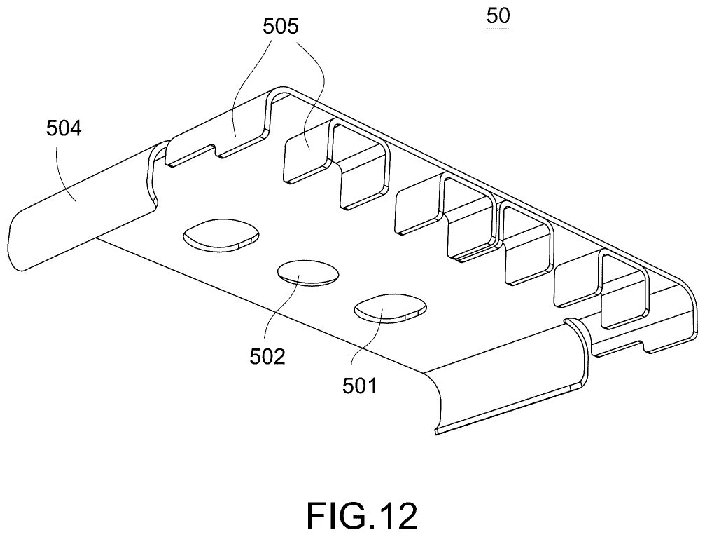

Further, as shown in FIG. 11 and FIG. 12, the plurality of the metal pins 503 of the metal housing 50 of the present disclosure are changed into a plurality of partition plates 505. The partition plate 505 is U-shaped. When the metal housing 50 is installed on the metal frame 20, each of the partition plates 505 correspondingly covers single one of the conductive wires 101, and at the same time, the partition plates 505 are electrically connected to the ground pins 403, so that the core wires 103 of the conductive wires 101 may block noise interferences on three sides, so that the signals transmitted by the core wires 103 are not affected or interfered by noise, thereby improving the quality of the transmitted signals.

FIG. 2 to FIG. 11 show schematic diagrams of the semi-finished product structure of the electrical connector structure 1 of the present disclosure. As shown in the drawings, the electrical connector structure 1 of the present disclosure includes at least one conductive-wire set 10, at least one metal frame 20, a fixing base 30, a circuit board 40, at least one metal housing 50, and an insulating layer 60.

As to the conductive-wire set 10, in the drawings, there are two conductive-wire sets 10. The conductive-wire set 10 is composed of (namely, includes) a plurality of conductive wires 101. Each conductive wire 101 includes an outer covering (plastic skin) 102, and includes a plurality of core wires 103 and a plurality of ground wires 104 inside the conductive wire 101. The ground wires 104 are bent onto one side of the outer coverings 102 of the conductive wires 101 or adjacent to the outer coverings 102.

As to the metal frame 20, in the drawings, there are two metal frames 20. Each of the two metal frames 20 includes a top part 204, two positioning parts 201, a slit 202, a bottom part 205, and a support plate 203. The two positioning parts 201 are symmetrical and perforated-shaped on the top part 204. The slit 202 is located between the two positioning parts 201. Moreover, the support plate 203 is located on the bottom part 205, and is bent inside the metal frame 20 and into the slit 202 (as shown in FIG. 11) to prevent the metal frame 20 from being crushed or deformed by external forces. After the metal frame 20 sleeves on the conductive wires 101 of the two conductive-wire sets 10, the ground wires 104 of the conductive wires 10 are bent and located on outer surfaces of the top parts 204 and the bottom parts 205 of the two metal frames 20, and are electrically connected to the top parts 204 and the bottom parts 205 of the two metal frames 20 (as shown in FIG. 2 and FIG. 10). This electrical connection method may cause that ground signals are induced on the metal frame 20 to form a ground isolation state to eliminate noises and to prevent transmitted signals from being interfered.

The fixing base 30 includes a front section 301 and a rear section 302. The front section 301 is arranged on the fixing base 30, and is located between the two metal frames 20 and the conductive wires 101 (as shown in FIG. 3, FIG. 10, and FIG. 11). The front section 301 extends backward to form the rear section 302. The rear section 302 is located on a rear side of the two metal frames 20, so that the fixing base 30 may firmly fix the two conductive-wire sets 10 and the two metal frames 20. In the drawings, the fixing base 30 is made of a plastic material 300.

The circuit board 40 includes a signal conductive line 400, a plurality of conductive terminals 401, a plurality of electrical pins 402, a plurality of ground pins 403, and a protruding board 404. The signal conductive line 400 is arranged on the circuit board 40. The conductive terminals 401 are located on one front side or two front sides of the circuit board 40, and are electrically connected to the signal conductive line 400. The electrical pins 402 and the ground pins 403 are located on one rear side or two rear sides of the circuit board 40. The protruding board 404 extends from a rear end of the circuit board 40. The protruding board 404 inserts between the conductive wires 101 of the two conductive-wire sets 10, so that the core wires 103 of the conductive wires 101 are electrically connected to the electrical pins 402 (as shown in FIG. 4, FIG. 8, and FIG. 9).

As to the metal housing 50, in the drawings, there are two metal housings 50. The metal housing 50 includes two through holes 501, an opening 502, a plurality of metal pins 503, and two fins 504. The two through holes 501 are symmetrical to each other, and are located on one side of each of the two metal housings 50, and are correspondingly positioned on the positioning parts 201 of the metal frame 20. The opening 502 is located between the two through holes 501, and corresponds to the slit 202. Moreover, the metal pins 503 are located at a front end of each of the two metal housings 50, and are electrically connected to the ground pins 403, so that a ground loop is formed between the conductive wires 101 and the circuit board 40 to eliminate the noises and form the ground isolation to prevent the transmitted signals from being interfered. Moreover, the fins 504 on both sides of the two metal housings 50 are located on both sides of the two metal frames 20 to prevent the both sides of the metal frames 20 from being squeezed and deformed (as shown in FIG. 5, FIG. 7, FIG. 8, FIG. 9, FIG. 10, and FIG. 11).

The insulating layer 60 pastes on the rear section 302 of the fixing base 30 and an outside of the two metal housings 50 to prevent the connector from the short-circuiting phenomenon (as shown in FIG. 6, FIG. 7, FIG. 8, FIG. 9, FIG. 10, and FIG. 11). In the drawings, the insulating layer 60 is a high temperature resistant tape.

Since the ground wires 104 of the conductive wires 101 of the two conductive-wire sets 10 mentioned above are bent and located on the outer surfaces of the top parts 204 and the bottom parts 205 of the two metal frames 20 and are electrically connected to the top parts 204 and the bottom parts 205 of the two metal frames 20, this electrical connection method may transmit the ground signals to the two metal frames 20 and the two metal housings 50 to form the ground isolation state to eliminate the noises and prevent the transmitted signals from being interfered, and at the same time, after the production is completed, the left-to-right width of the connector may also be reduced.

Further, as shown in FIG. 11 and FIG. 12, the plurality of the metal pins 503 of the metal housing 50 of the present disclosure are changed into a plurality of partition plates 505. The partition plate 505 is U-shaped. When the metal housing 50 is installed on the metal frame 20, each of the partition plates 505 correspondingly covers single one of the conductive wires 101, and at the same time, the partition plates 505 are electrically connected to the ground pins 403, so that the core wires 103 of the conductive wires 101 may block noise interferences on three sides, so that the signals transmitted by the core wires 103 are not affected or interfered by noise, thereby improving the quality of the transmitted signals.

However, the above descriptions are only preferred embodiments of the present disclosure and are not intended to limit the scope of the patent protection of the present disclosure. Therefore, all equivalent changes made by using the contents of the descriptions or drawings of the present disclosure are similarly included in the scope of the patent protection of the present disclosure.

What is claimed is:

1. An electrical connector manufacturing method comprising:
a) providing at least one conductive-wire set, wherein the conductive-wire set is composed of a plurality of conductive wires, and outer coverings of the conductive wires are removed to expose a plurality of core wires and a plurality of ground wires, and the ground wires are bent onto one side of the conductive wires;
b) providing at least one metal frame, wherein the metal frame is installed on the conductive wires, so that the ground wires which are bent are located on outer surfaces of a top part and a bottom part of the metal frame, and are electrically connected to the top part and the bottom part of the metal frame;
c) a plastic material covering the conductive wires through an injection molding technology to form a fixing base, wherein a part of the fixing base is located between the conductive wires and the metal frame, and the other part of the fixing base is located on a rear side of the metal frame;
d) providing a circuit board, wherein the circuit board is electrically connected to the core wires; and
e) providing at least one metal housing, wherein the metal housing is installed on the top part of the metal frame, and the metal housing is electrically connected to the metal frame and the circuit board.

2. The electrical connector manufacturing method of claim 1, wherein in the step b, the metal frame comprises two positioning parts, a slit, and a support plate; the two positioning parts are symmetrical and perforated-shaped on the top part; the slit is located between the two positioning parts; the support plate is located on the bottom part of the metal frame; the support plate is bent inside the metal frame and into the slit.

3. The electrical connector manufacturing method of claim 1, wherein in the step c, the fixing base comprises a front section and a rear section; the front section is located between the metal frame and the conductive wires; the rear section extends from the front section of the fixing base; the rear section is located at the rear side of the metal frame.

4. The electrical connector manufacturing method of claim 2, wherein in the step d, the circuit board comprises a signal conductive line, a plurality of conductive terminals, a plurality of electrical pins, a plurality of ground pins, and a protruding board; the signal conductive line is arranged on the circuit board; the conductive terminals are located on one front side or two front sides of the circuit board, and are electrically connected to the signal conductive line; the electrical pins and the ground pins are located on one rear side or two rear sides of the circuit board; the protruding board extends from a rear end of the circuit board; the protruding board inserts between the conductive wires of the two conductive-wire sets, so that the core wires of the conductive wires are electrically connected to the electrical pins.

5. The electrical connector manufacturing method of claim 4, wherein in the step e, the metal housing comprises two through holes, an opening, a plurality of metal pins, and two fins; the two through holes are symmetrical to each other, and are located on one side of the metal housing, and are correspondingly positioned on the positioning parts of the metal frame; the opening is located between the two through holes, and corresponds to the slit; the metal pins are located at a front end of the metal housing, and are electrically connected to the ground pins; the two fins are located at both sides of the metal housing respectively, and on both sides of the metal frame respectively.

6. The electrical connector manufacturing method of claim 1, further comprising:
f) pasting an adhesive tape on the rear section of the fixing base and an outside of the metal housing to form an insulating layer.

7. The electrical connector manufacturing method of claim 6, wherein the insulating layer is a high temperature resistant tape.

8. The electrical connector manufacturing method of claim 5, wherein in the step e, the metal housing comprises a plurality of partition plates; the partition plate is U-shaped; when the metal housing is installed on the metal frame, each of the partition plates correspondingly covers single one of the conductive wires, and the partition plates are electrically connected to the ground pins, so that the core wires of the conductive wires block noise interferences on three sides.

9. An electrical connector structure comprising:
at least one conductive-wire set composed of a plurality of conductive wires, wherein the conductive wires comprise a plurality of core wires and a plurality of ground wires, and the ground wires are bent onto one outside of the conductive wires;
at least one metal frame installed on the conductive-wire set, and comprising a top part and a bottom part, so that the ground wires which are bent are located on and electrically connected to outer surfaces of the top part and the bottom part;
a fixing base comprising a front section and a rear section, wherein the front section is located between the metal frame and the conductive wires, and the front section extends backward to form the rear section, and the rear section is located at a rear side of the metal frame;
a circuit board electrically connected to the core wires; and
at least one metal housing installed on the top part of the metal frame, and electrically connected to the metal frame and the circuit board.

10. The electrical connector structure of claim 9, wherein the metal frame comprises two positioning parts, a slit, and a support plate; the two positioning parts are symmetrical and perforated-shaped on the top part; the slit is located between the two positioning parts; the support plate is located on the bottom part, and is bent inside the metal frame and into the slit.

11. The electrical connector structure of claim 10, wherein the circuit board comprises a signal conductive line, a plurality of conductive terminals, a plurality of electrical pins, a plurality of ground pins, and a protruding board; the signal conductive line is arranged on the circuit board; the conductive terminals are located on one front side or two front sides of the circuit board, and are electrically connected to the signal conductive line; the electrical pins and the ground pins are located on one rear side or two rear sides of the circuit board; the protruding board extends from a rear end of the circuit board; the protruding board inserts between the conductive wires of the two conductive-wire sets, so that the core wires of the conductive wires are electrically connected to the electrical pins.

12. The electrical connector structure of claim 11, wherein the metal housing comprises two through holes, an opening, a plurality of metal pins, and two fins; the two through holes are symmetrical to each other, and are located on one side of the metal housing, and are correspondingly positioned on the positioning parts of the metal frame; the opening is located between the two through holes, and corresponds to the slit; the metal pins are located at a front end of the metal housing, and are electrically connected to the ground pins so a ground loop is formed between the conductive wires and the circuit board; the fin is located on each side of the metal housing; the two fins are located on both sides of the metal frame respectively.

13. The electrical connector structure of claim 9, wherein the fixing base is made of a plastic material.

14. The electrical connector structure of claim 9, further comprising an insulating layer pasting on the rear section of the fixing base and an outside of the metal housing.

15. The electrical connector structure of claim 14, wherein the insulating layer is a high temperature resistant tape.

16. The electrical connector structure of claim 11, wherein the metal housing comprises a plurality of partition plates; the partition plate is U-shaped; when the metal housing is installed on the metal frame, each of the partition plates correspondingly covers single one of the conductive wires, and the partition plates are electrically connected to the ground pins, so that the core wires of the conductive wires block noise interferences on three sides.
